(19) United States
(12) Patent Application Publication
(10) Pub. No.: US 2015/0370459 A1
(43) Pub. Date: Dec. 24, 2015

(54) SYSTEM, METHOD AND COMPUTER PROGRAM PRODUCT FOR GENERATING A MOBILE APPLICATION BASED ON PAGE METADATA

(71) Applicant: INSTITUTE FOR INFORMATION INDUSTRY, Taipei City (TW)

(72) Inventors: Shih-Chun CHOU, Taipei City (TW); Bo-Fu LIU, Tainan City (TW); Jih-Yiing LIN, Chiayi County (TW); Peng-Hua CHU, Tainan City (TW); Yi-Chun HSIEH, Taipei City (TW); Yu-Hung LIN, Kaohsiung City (TW)

(21) Appl. No.: 14/509,135

(22) Filed: Oct. 8, 2014

(30) Foreign Application Priority Data
Jun. 18, 2014 (TW) 103121040

(51) Int. Cl. G06F 3/0484; G06F 3/0483; G06F 17/30

(52) U.S. Cl. CPC G06F 3/04845; G06F 17/3089; G06F 3/04842; G06F 3/0483

(57) ABSTRACT

In a system and method for generating a mobile application, a static picture constructing a static object, and first and second pictures associated with an interactive element are defined from multiple digital pictures based on page metadata corresponding to the digital pictures. Transformed static, first and second pictures are generated based on the static, first and second pictures and on their original and corrected specifications. The page metadata, a preview page generated based on the transformed static and first pictures, a background page generated based on the transformed static picture, and the transformed first and second pictures are packaged to generate the mobile application.

### CROSS-REFERENCE TO RELATED APPLICATION

This application claims priority to Taiwanese Application No. 103121040, filed on Jun. 18, 2014, the contents of which are hereby incorporated by reference.

### FIELD OF THE INVENTION

The invention relates to techniques for generating a mobile application based on page metadata, and more particularly to a system, method and computer program product for generating, based on page metadata, a mobile application associated with a digital publication.

### BACKGROUND OF THE INVENTION

Increasingly, books, magazines and other publications are becoming available in digital form. A user may obtain a digital version of a particular publication for use with an electronic reader (e-reader) on a computing device, such as a smart phone, a tablet computer, an electronic reader device, or the like. For example, a mobile application associated with a digital publication may be executed by a smart phone or a tablet computer to display the digital publication, such as an electronic book (e-book) or an electronic magazine (e-magazine). Generally, picture objects, which are associated with an interactive element and included in the digital publication, have positioning data that is in a floating point format and that is generated by an editing program. During execution of the mobile application, the positioning data of the picture objects is converted from the floating point format into an integer point format by an e-reader of the smart phone or tablet computer. As a result, the picture objects, a suitable one being displayed at a time on the smart phone or tablet computer in the integer point format depending on a state of the interactive element (e.g., has not been triggered, is currently being triggered, or has already been triggered), may have differences in terms of placement and/or size, (e.g., shifting or displacement in page layout is visible during user interaction with the interactive element where a transition from one picture object to another occurs), thereby affecting the user's reading experience.

In order to solve the above problem, a conventional trapping process is used to trap each picture object associated with the same interactive element into a size-matched trap area of a corresponding element page. A remaining area of the corresponding element page is in the form of a transparent padding area. Due to the trapping process, the amount of data corresponding to each interactive element is increased. Accordingly, the size of the mobile application may increase with increase in the number of interactive elements, thereby adversely affecting downloading time/cost and cloud storage space for the mobile application, and load performance of the interactive elements.

### SUMMARY OF THE INVENTION

Therefore, an object of the present invention is to provide a system, method and computer program product for generating a mobile application based on page metadata that can overcome the aforesaid the drawbacks of the prior art.

According to one aspect of the present invention, there is provided a system for generating a mobile application based on page metadata. The system comprises:

a storage module for storing the page metadata, and a plurality of digital pictures that correspond to the page metadata and that are associated with at least one static object and at least one interactive element; and

a processing unit coupled to the storage module, the processing unit including
an editor module for defining, based on the page metadata, at least one static picture and at least one element picture set, which includes a first picture and a second picture, from the digital pictures stored in the storage module, the static picture serving as the static object, the element picture set being associated with the interactive element, each of the static picture and the first and second pictures having an original specification,
a picture transformation module for transforming the original specifications of the static picture and the first and second pictures respectively into corrected specifications in accordance with a specification transformation rule, and a transformed static picture based on the static picture with reference to the original and corrected specifications associated with the static picture, a transformed first picture based on the first picture with reference to the original and corrected specifications associated with the first picture, and a transformed second picture based on the second picture with reference to the original and corrected specifications associated with the second picture,
a page generation module for generating a preview page based on the transformed static picture and the transformed first picture, and for generating, based on the transformed static picture, a background page that corresponds to the preview page, and
a packaging module for packaging the page metadata, the preview page, the background page, the transformed first picture and the transformed second picture to generate the mobile application.

After the mobile application is loaded into and executed by a mobile device, the mobile application enables the mobile device to be operable in one of a preview mode and a view mode. The preview page is capable of being displayed on the mobile device when the mobile device is in the preview mode. The background page is capable of being displayed on the mobile device together with the transformed first picture by superimposing the transformed first picture on the background page when the mobile device is in the view mode while the interactive element has not yet been triggered. The background page is displayed on the mobile device together with the transformed second picture by superimposing the transformed second picture on the background page when the mobile device is in the view mode while the interactive element has already been triggered.

According to another aspect of the present invention, there is provided a method for generating a mobile application based on page metadata. The page metadata corresponds to a plurality of digital pictures that are associated with at least one static object and at least one interactive element. The method is to be implemented by a system including an editor module, a picture transformation module, a page generation module and a packaging module, and comprises the steps of:

a) defining, by the editor module, at least one static picture, and at least one element picture set, which includes a first picture and a second picture, from among the digital pictures based on the page metadata, the static picture serving as the static object, the element picture set being associated with the interactive element, each of the static picture and the first and second pictures having an original specification;

b) by the picture transformation module, transforming the original specifications of the static picture and the first and second pictures respectively into corrected specifications in accordance with a specification transformation rule, and generating a transformed static picture based on the static picture with reference to the original and corrected specifications associated with the static picture, a transformed first picture based on the first picture with reference to the original and corrected specifications associated with the first picture, and a transformed second picture based on the second picture with reference to the original and corrected specifications associated with the second picture;

c) by the page generation module, generating a preview page based on the transformed static picture and the transformed first picture, and generating, based on the transformed static picture, a background page that corresponds to the preview page; and

d) packaging, by the packaging module, the page metadata, the preview page, the background page, the transformed first picture and the transformed second picture to generate the mobile application.

After the mobile application is loaded into and executed by a mobile device, the mobile application enables the mobile device to operate in one of a preview mode and a view mode. The preview page is capable of being displayed on the mobile device when the mobile device is in the preview mode. The background page is capable of being displayed on the mobile device together with the transformed first picture by superimposing the transformed first picture on the background page when the mobile device is in the view mode while the interactive element has not yet been triggered. The background page is displayed on the mobile device together with the transformed second picture by superimposing the transformed second picture on the background page when the mobile device is in the view mode while the interactive element has already been triggered.

According to a further aspect of the present invention, there is provided a computer program product, stored on a non-transitory computer readable medium, for generating a mobile application based on page metadata. The page metadata corresponds to a plurality of digital pictures that are associated with at least one static object and at least one interactive element. The computer program product comprises program instructions for causing a computer to:

define at least one static picture, and at least one element picture set, which includes a first picture and a second picture, from among the digital pictures based on the page metadata, the static picture constructing the static object, the element picture set being associated with the interactive element, each of the static picture and the first and second pictures having an original specification;

generate corrected specifications respectively from the original specifications respectively of the static picture and the first and second pictures in accordance with a specification transformation rule, and generate a transformed static picture based on the static picture with reference to the original and corrected specifications associated with the static picture, a transformed first picture based on the first picture with reference to the original and corrected specifications associated with the first picture, and a transformed second picture based on the second picture with reference to the original and corrected specifications associated with the second picture;

generate a preview page based on the transformed static picture and the transformed first picture, and generate, based on the transformed static picture, a background page that corresponds to the preview page; and

package the page metadata, the preview page, the background page, the transformed first picture and the transformed second picture to generate the mobile application.

After the application is loaded into and executed by a mobile device, the mobile application enables the mobile device to operate in one of a preview mode and a view mode. The preview page is capable of being displayed on the mobile device when the mobile device is in the preview mode. The background page is capable of being displayed on the mobile device together with the transformed first picture by superimposing the transformed first picture on the background page when the mobile device is in the view mode while the interactive element has not yet been triggered. The background page is displayed on the mobile device together with the transformed second picture by superimposing the transformed second picture on the background page when the mobile device is in the view mode while the interactive element has already been triggered.

### BRIEF DESCRIPTION OF THE DRAWINGS

Other features and advantages of the present invention will become apparent in the following detailed description of the embodiment with reference to the accompanying drawings, of which:

FIG. 1 is a block diagram illustrating the embodiment of a system for generating a mobile application based on page metadata according to the present invention;

FIG. 2 illustrates an exemplary element picture set of the embodiment;

FIG. 3 illustrates an original specification of a static picture, a first picture, a second picture, a third picture or a resultant picture of the embodiment;

FIG. 4 illustrates a corrected specification of a transformed static picture, a transformed first picture, a transformed second picture or a transformed third picture of the embodiment;

FIG. 5 illustrates exemplary relationships between a static picture and a transformed static picture of the embodiment;

FIG. 6 illustrates an exemplary preview page of the embodiment;

FIG. 7 illustrates an exemplary view page of the embodiment;

FIGS. 8 to 10 illustrate exemplary displays on a mobile device after execution of the mobile application generated in accordance with the embodiment; and

FIG. 11 is a flow chart of the embodiment of a method for generating a mobile application based on page metadata in accordance with the present invention.

### DETAILED DESCRIPTION OF THE EMBODIMENT

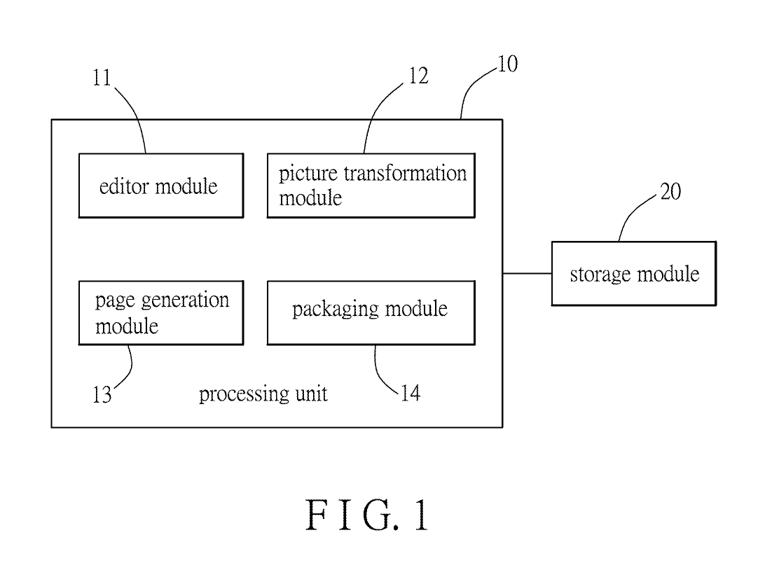

Referring to FIG. 1, the embodiment of a system for generating a mobile application based on page metadata according to the present invention includes a storage module 20 and a processing unit 10. In this embodiment, the mobile application is associated with a digital publication, such as an e-book, an e-magazine, e-news, an e-dictionary, an e-commercial advertisement or the like, which includes a plurality of page contents, and is executable by a mobile device, such as a smart phone, a tablet computer or an e-reader device. When the mobile application is executed by the mobile device, the digital publication is presented on the mobile device. It should be noted that the mobile application may also be integrated with other program(s)/software(s), such as a program associated with mobile browsing.

The storage module 20 stores the page metadata that is associated with the page contents of the digital publication, and a plurality of digital pictures that correspond to the page metadata and that are associated with a plurality of static objects and a plurality of interactive elements to be perceived by a user. For example, the page metadata includes relationships among the digital pictures, information related to each of the digital pictures, such as which page it belongs to in the digital publication, etc. In particular, each digital picture is associated with a static object or an interactive element, and may be, but not limited to, a rectangular image block, which may be generated by an image editor based on, but not limited to, a paper published material. The digital pictures may illustrate a wide variety of contents. As one example, each digital picture may illustrate a text-based content or/and an image-based content. Each interactive element can be optionally triggered by the user when displayed on a mobile device so as to provide a certain interaction result, for example, display of a specific image or a specific page, linking to a specific web page or the like.

The processing unit 10 is coupled to the storage module 20, and includes an editor module 11, a picture transformation module 12, a page generation module 13 and a packaging module 14.

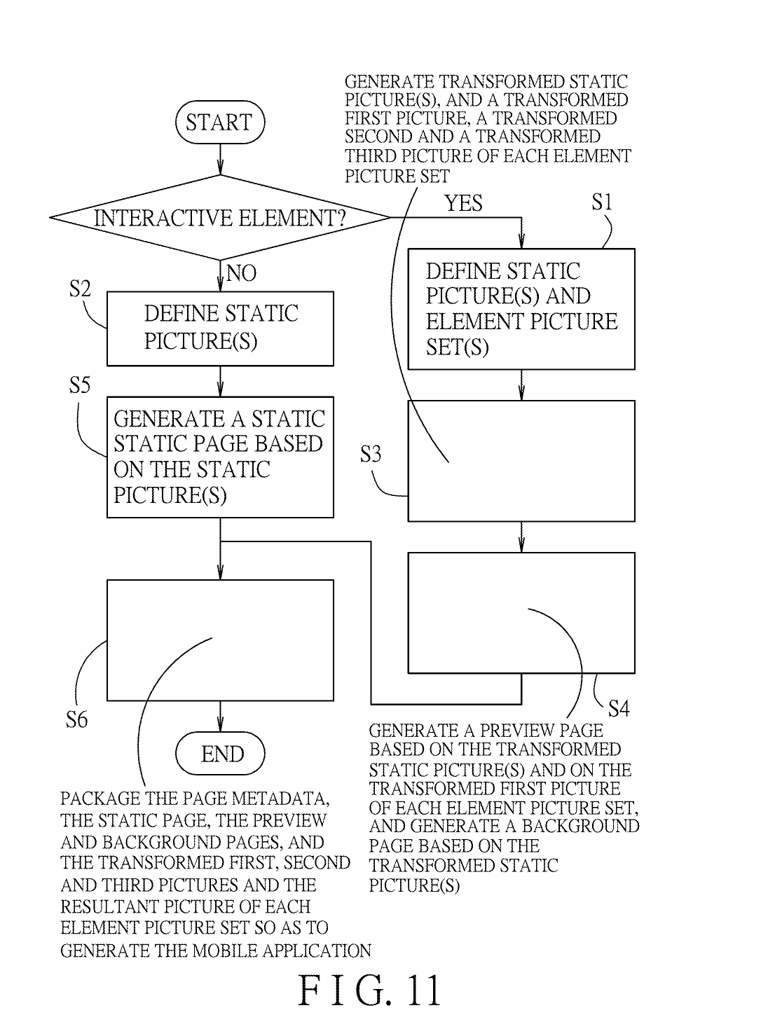

Further referring to FIG. 11, the embodiment of a method for generating a mobile application based on page metadata according to the present invention is implemented by the system of FIG. 1.

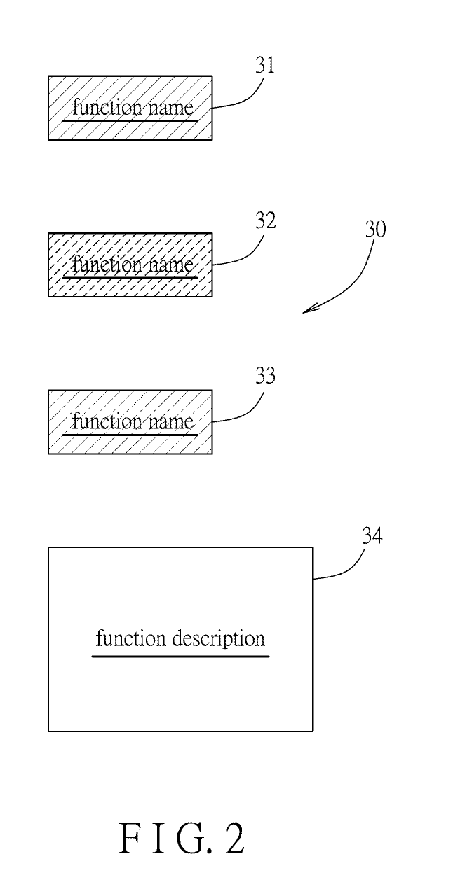

Instep S1, for each page content including at least one static object and at least one interactive element, the editor module 11 defines, based on the page metadata, at least one static picture and at least one element picture set from among the digital pictures stored in the storage module 20, wherein each static picture serves as a corresponding static object, and each element picture set is associated with a corresponding interactive element. In this embodiment, each element picture set includes: a first picture that presents an appearance of the corresponding interactive element when the corresponding interactive element has not yet been triggered; a second picture that presents the appearance of the corresponding interactive element when the corresponding interactive element has already been triggered; a third picture that presents the appearance of the corresponding interactive element as the corresponding interactive element is being triggered; and a resultant picture that presents the interaction result provided by triggering the corresponding interactive element. For example, the resultant picture may be a specific image, a specific page image, a specific web page or the like. It should be noted that, in other embodiments, the third picture in each element picture set may be omitted. In this embodiment, the first to third pictures of each element picture set may have, but is not limited to, the same size. In one example, as shown in FIG. 2, one element picture set 30, which is associated with an interactive element for providing a function description as an interactive result, includes first, second and third pictures 31, 32, 33, and a resultant picture 34. The first, second and third pictures 31, 32, 33 have the same size, illustrate the same text content of a function name, and have, for example, different background colors, as indicated respectively by diagonal solid lines, dash lines and imaginary lines in FIG. 2. The resultant picture 34 illustrates a text content of the function description.

In step S2, for each page content free of any interactive element (but, of course, has at least one static object), the editor module 11 only defines, based on the page metadata, at least one static picture, which serves as a corresponding static object, from among the digital pictures stored in the storage module 20.

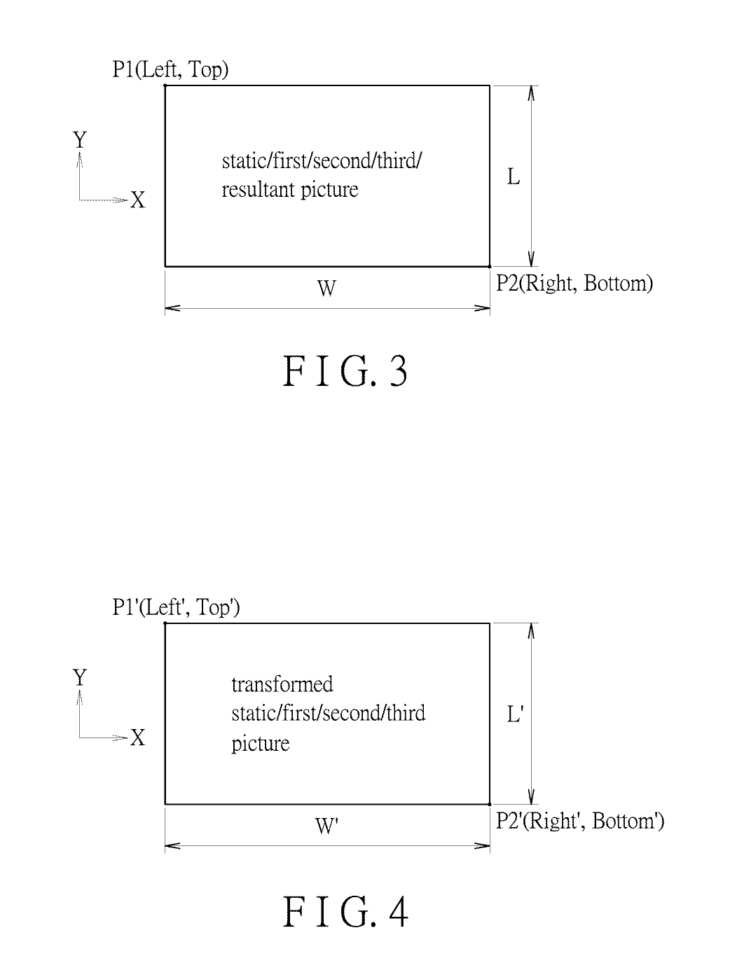

Each of the static picture(s), and the first to third pictures and the resultant picture of each element picture set, being in the form of the rectangular image block as mentioned above, has a respective original specification, referring to FIG. 3, that includes: an original width value (W) in an X direction; an original length value (L) in a Y direction; a main positioning point (P1), which is located at an upper left corner of the corresponding rectangular image block and whose two-dimension (2D) coordinate is represented as (Left, Top); and an auxiliary positioning point (P2), which is located at a lower right corner of the same image block and whose 2D coordinate is represented as (Right, Bottom), where Right=Left+W and Bottom=Top+L. It is noted that, generally, each of W, L, Left, Top, Right and Bottom may be a non-integer, i.e., a number having a decimal component.

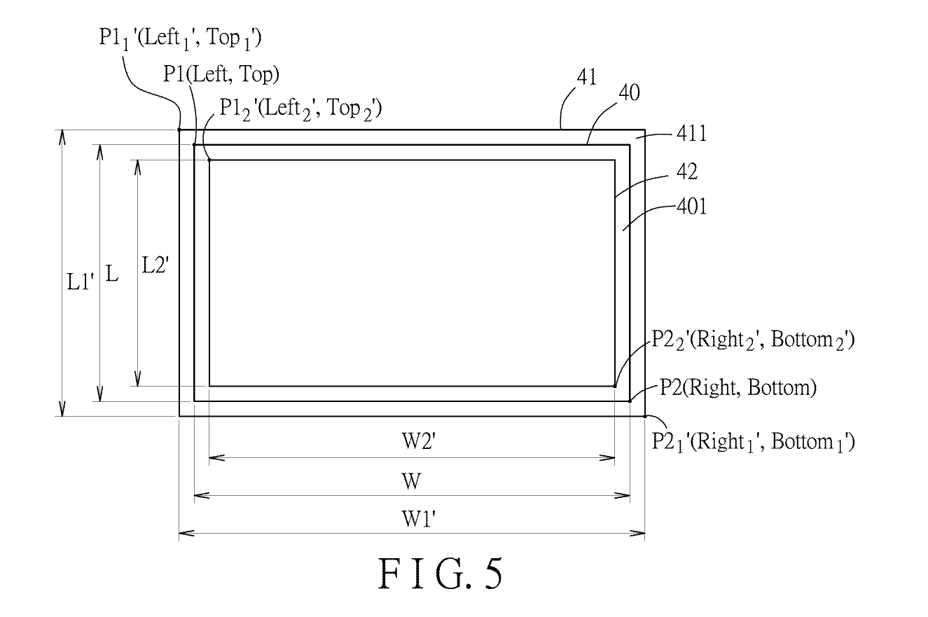

In step S3, for each page content having the interactive element(s), the picture transformation module 12 transforms the original specifications of the static picture(s) and the first to third pictures of each element picture set respectively into corrected specifications in accordance with a specification transformation rule, e.g., a bounding box transformation rule. Then, the picture transformation module 12 generates at least one transformed static picture based on the static picture(s) with reference to the original and corrected specifications associated with the static picture(s). The picture transformation module 12 further generates at least one transformed first picture based on the first picture(s) of the element picture set(s) with reference to the original and corrected specifications associated with the first picture(s), generates at least one transformed second picture based on the second picture(s) of the element picture set(s) with reference to the original and corrected specifications associated with the second picture(s), and generates at least one transformed third picture based on the third picture(s) of the element picture set(s) with reference to the original and corrected specifications associated with the third picture(s). In this embodiment, the transformed static picture(s), the transformed first picture(s), the transformed second picture(s) and the transformed third picture(s) are each in the form of a rectangular image block having the respective corrected specification. Similarly, referring to FIG. 4, the corrected specification for each of the transformed static picture(s), the transformed first picture(s), the transformed second picture(s) and the transformed third picture(s) includes: two integer corrected dimension values, i.e., an integer corrected width value (W′) in the X direction and an integer corrected length value (L′) in the Y direction; a corrected main positioning point (P1′), which is located at an upper left corner of the corresponding rectangular image block and whose 2D coordinate is represented as (Left′, Top′), where Left′ and Top′ are integers; and a corrected auxiliary positioning point (P2′), which is located at a lower right corner of the corresponding rectangular image block and whose 2D coordinate is represented as (Right′, Bottom′), where Right′ and Bottom′ are integers. It is nearly always true that Top, Left, Bottom and Right are non-integers, and according to the specification transformation rule: Top′ is an integer smaller than and closest to Top, Left′ is an integer smaller than and closest to Left, Bottom′ is an integer greater than and closest to Bottom, and Right′ is an integer greater than and closest to Right; or Top′ is an integer greater than and closest to Top, Left′ is an integer greater than and closest to Left, Bottom′ is an integer smaller than and closest to Bottom, and Right′ is an integer smaller than and closest to Right. Thus, the corrected width and length values (W′, L′) are obtained as follows:

W′=Right′−Left′, and L′=Bottom′−Top′.

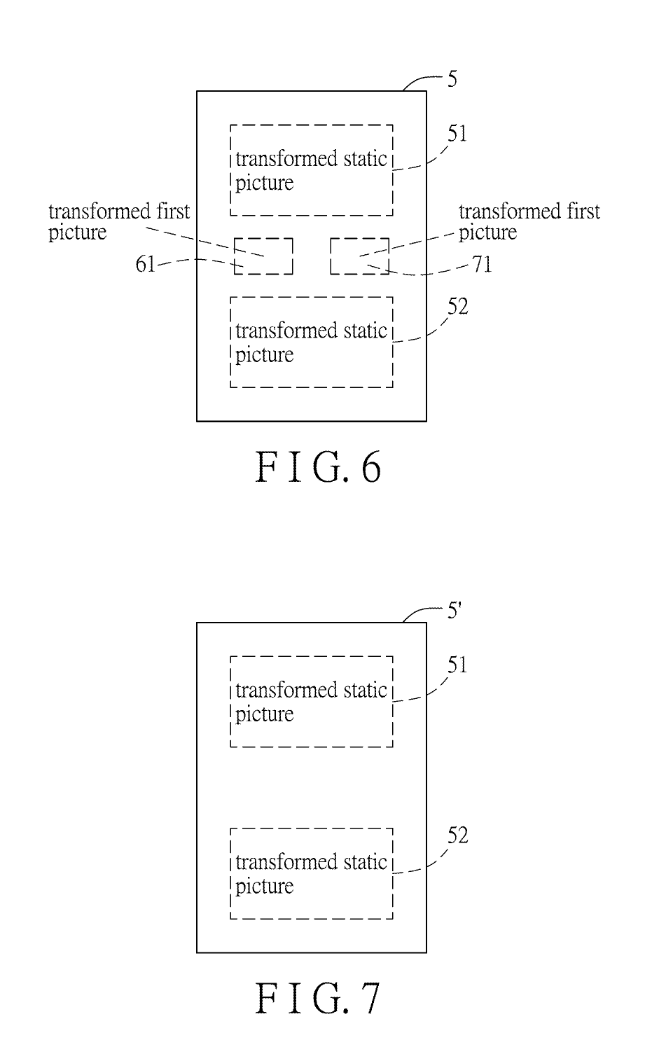

Referring to FIG. 5, for example, an image block 40 is shown to represent one static picture. According to the specification transformation rule, if Left₁′ is an integer smaller than and closest to Left, Tom′ is an integer smaller than and closest to Top, Right₁′ is an integer greater than and closest to Right, and Bottom₁′ is an integer greater than and closest to Bottom, the main and auxiliary positioning points (P1, P2) of the static picture are adjusted respectively into the corrected main and auxiliary positioning points (P1₁′, P2₁′) as shown. In addition, the corrected width value (W1′) is greater than the original width value (W), and the corrected length value (L₁′) is greater than the original length value (L). In this case, the picture transformation module 12 combines the image block 40, i.e., the static picture, with a padding loop portion 411, which surrounds the image block 40 and which is determined based on the original and corrected specifications associated with the static picture, to generate an image block 41 that serves as the transformed static picture. If Left₂′ is an integer greater than and closest to Left, Top₂′ is an integer greater than and closest to Top, Right₂′ is an integer smaller than and closest to Right, and Bottom₂′ is an integer smaller than and closest to Bottom, the main and auxiliary positioning points (P1, P2) of the static picture are adjusted respectively into the corrected main and auxiliary positioning points (P1₂′, P2₂′) as shown. In addition, the corrected width value (W₂′) is smaller than the original width value (W), and the corrected length value (L₂′) is smaller than the original length value (L). In this case, the picture transformation module 12 cuts from the image block 40 an outer loop image portion 401, which is determined based on the original and corrected specifications associated with the static picture, to leave a rectangular inner image portion 42 to serve as the transformed static picture.

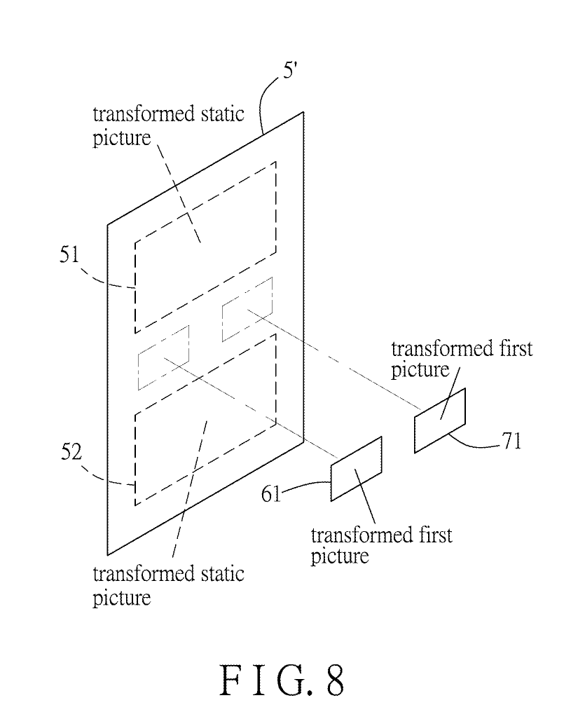

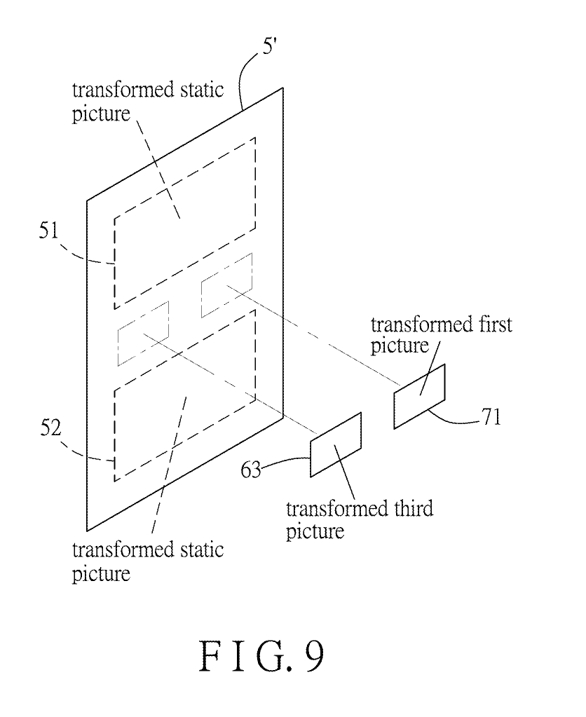

In step S4, for each page content having the interactive element(s), the page generation module 13 generates a preview page based on the transformed static picture(s) and the transformed first picture(s), and generates, based on the transformed static picture(s), a background page that corresponds to the preview page. As one example, for one page content having two static objects and two interactive elements, referring to FIG. 6, a preview page 5 is shown to include two transformed static pictures 51, 52 that correspond respectively to the two static objects, and two transformed first pictures 61, 71 that are associated respectively with the two interactive elements. Accordingly, referring to FIG. 7, a background page 5′ corresponding to the preview page 5 is shown to merely include the transformed static pictures 51, 52.

In step S5, for each page content free of any interactive element, the page generation module 13 generates a static page based on the static picture(s). It is noted that the static page may serve as a preview or view page corresponding to the page content.

In step S6, the packaging module 14 packages the page metadata, the static page that corresponds to each page content free of any interactive element, and the preview and background pages, the transformed first, second, third and resultant pictures that correspond to each page content having the interactive element(s) so as to generate the mobile application.

The mobile application is able to be loaded into and executable by a mobile device, such as a smart phone or a tablet computer, which includes, for example, a processor and a touch display panel. After the mobile device executes the mobile application loaded therein, the mobile device, which functions as an e-reader device, is operable in one of a preview mode and a view mode. When the mobile device is in the preview mode, the preview page(s) are capable of being optionally displayed on the touch display panel in order.

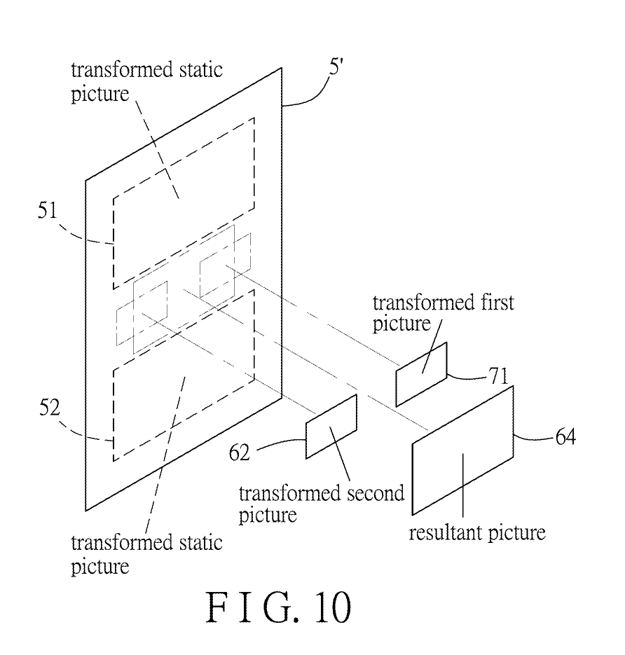

When the mobile device is in the view mode for viewing one page content having the interactive element(s) while no interactive element has yet been triggered, the processor enables the touch display panel to display the background page which corresponds to said one page content, together with the transformed first picture(s) which is/are associated with the interactive element(s), by superimposing the transformed first picture(s) on the background page. According to the same example of FIGS. 6 and 7, in this case, the background page 5′ is displayed on the touch display panel together with the transformed first pictures 61, 71 by superimposing the transformed first pictures 61, 71 on the background page 5′, as shown in FIG. 8. Thereafter, upon detecting by the touch display panel that an object, such as a user's finger, touches an area of the touch display panel that corresponds to a position of one transformed first picture 61 or 71 displayed on the touch display panel, i.e., one interactive element represented by said one transformed first picture 61 or 71 is being triggered, the processor enables the touch display panel to display the background page 5′ together with the transformed third picture which is associated with said one interactive element that is being triggered, and with the transformed first picture(s) which is/are associated with the remaining interactive element(s) that is/are not being triggered, by superimposing the transformed third picture and the transformed first picture(s) on the background page. Similarly, according to the same example of FIGS. 6 and 7, if one interactive element represented by the transformed first picture 61 is being triggered, in this case, the background page 5′ is displayed on the touch display panel together with the transformed first picture 71 and with a transformed third picture 63 which is associated with said one interactive element, by superimposing the transformed first picture 71 and the transformed third picture 63 on the background page 5′, as shown in FIG. 9. Subsequently, when said one interactive element has already been triggered, the processor enables the touch display panel to display the background page together with the transformed second picture and the resultant picture which are associated with said one interactive element, and with the transformed first picture(s) which is/are associated with the remaining interactive element(s), by superimposing the resultant picture on the background page and on the transformed second picture and the transformed first picture(s). Similarly, according to the same example of FIGS. 6, 7 and 9, if said one interactive element has already been triggered, in this case, the background page 5′ is displayed on the touch display panel together with the transformed first picture 71 and with the transformed second picture 62 and the resultant picture 64 that are associated with said one interactive element, by superimposing the resultant picture 64 on the background picture 5′ and on the transformed first picture 71 and the transformed second picture 62 superimposed on the background page 5′, as shown in FIG. 10.

In sum, the transformed first to third pictures, which are associated with the interactive element(s) included in each page content and which are packaged into the mobile application, respectively have the corrected specifications, each of which includes integer corrected width and length values, and corrected main and auxiliary positioning points of 2D coordinates having integer coordinate components. Therefore, when the mobile application generated by the system of this invention is executed by a mobile device for a user to read the digital publication associated with the mobile application, for each page content of the digital publication, the transformed static picture(s), and the transformed first, second or third picture associated with each interactive element will not shift and deform during user interaction with the interactive element and during transition of the mobile device from the preview mode to the view mode, thereby avoiding changes in page layout while the user reads. In addition, each transformed first, second or third picture is easily generated based on the first, second or third picture and requires a relatively small amount of data compared to the aforesaid element page in the prior art. Therefore, the size of the mobile application generated by the system of this invention may be relatively reduced compared to the prior art, thereby saving downloading time/cost and cloud storage space for the mobile application, and enhancing load performance of each interactive element.

A computer program including a plurality of program instructions may be stored in a memory (not shown) or the storage module 20. Such computer program, when executed, enables the processing unit 21 to perform the operations previously described. The memory and the storage module 20 are possible examples of non-transitory computer-readable media.

In one embodiment, the processing unit 21 may be implemented by a chipset (i.e., a group of integrated circuits designed to work and be sold as a module for performing related operations, etc.), and/or any other integrated circuit for that matter.

Still yet, the system of this invention may be implemented by a general computer system, a circuit board system, an application-specific system, and/or any other desired system so configured as to perform the above-described operations.

Further, while not shown, the system of the invention may be coupled to a network (e.g. a local area network (LAN), a wireless network, a wide area network (WAN) such as the Internet, a peer-to-peer network, a cable network, etc.) for communication purposes.

While the present invention has been described in connection with what is considered the most practical and embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A system for generating a mobile application based on page metadata, said system comprising:
a storage module for storing the page metadata, and a plurality of digital pictures that correspond to the page metadata and that are associated with at least one static object and at least one interactive element; and
a processing unit coupled to said storage module, said processing unit including
an editor module for defining, based on the page metadata, at least one static picture and at least one element picture set, which includes a first picture and a second picture, from the digital pictures stored in said storage module, the static picture serving as the static object, the element picture set being associated with the interactive element, each of the static picture and the first and second pictures having an original specification,
a picture transformation module for transforming the original specifications of the static picture and the first and second pictures respectively into corrected specifications in accordance with a specification transformation rule, and for generating a transformed static picture based on the static picture with reference to the original and corrected specifications associated with the static picture, a transformed first picture based on the first picture with reference to the original and corrected specifications associated with the first picture, and a transformed second picture based on the second picture with reference to the original and corrected specifications associated with the second picture,
a page generation module for generating a preview page based on the transformed static picture and the transformed first picture, and for generating, based on the transformed static picture, a background page that corresponds to the preview page, and
a packaging module for packaging the page metadata, the preview page, the background page, the transformed first picture and the transformed second picture to generate the mobile application;
wherein, after the mobile application is loaded into and executed by a mobile device, the mobile application enables the mobile device to be operable in one of a preview mode and a view mode,
the preview page is capable of being displayed on the mobile device when the mobile device is in the preview mode,
the background page is capable of being displayed on the mobile device together with the transformed first picture by superimposing the transformed first picture on the background page when the mobile device is in the view mode while the interactive element has not yet been triggered, and
the background page is displayed on the mobile device together with the transformed second picture by superimposing the transformed second picture on the background page when the mobile device is in the view mode while the interactive element has already been triggered.

2. The system as claimed in claim 1, wherein the corrected specifications serve respectively as specifications of the transformed static picture, the transformed first picture and the transformed second picture, and each of the corrected specifications includes two integer corrected dimension values, and a corrected main positioning point that has a two-dimensional coordinate of two integer coordinate components.

3. The system as claimed in claim 2, wherein each of the static picture, the first and second pictures, the transformed static picture, the transformed first picture and the transformed second picture is a rectangular image block, the rectangular image block for each of the transformed static picture, the transformed first picture and the transformed second picture having an integer corrected width value and an integer corrected length value that serve as the integer corrected dimension values of the corresponding corrected specification.

4. The system as claimed in claim 2, wherein:
each of the static picture and the first and second pictures is a rectangular image block, and the original specification for each of the static picture and the first and second pictures includes an original width value (W), an original length value (L), a main positioning point located at an upper left corner of the rectangular image block, and an auxiliary positioning point located at a lower right corner of the rectangular image block;
the corrected specification for each of the transformed static picture, the transformed first picture and the transformed second picture includes a corrected width value (W′) and a corrected length value (L′), which serve as the corrected dimension values, the corrected ma in positioning point located at an upper left corner of the rectangular image block, and a corrected auxiliary positioning point located at a lower right corner of the rectangular image block; and
the two-dimensional coordinates of the main and auxiliary positioning points are represented respectively as (Left, Top) and (Right, Bottom), where Right=Left+W and Bottom=Top+L, and the two-dimensional coordinates of the corrected main and auxiliary positioning points are represented respectively as (Left′, Top′) and (Right′, Bottom′),
according to the specification transformation rule, Top′ is an integer smaller than and closest to Top if Top is not an integer, Left′ is an integer smaller than and closest to Left if Left is not an integer, Bottom′ is an integer greater than and closest to Bottom if Bottom is not an integer, and Right′ is an integer greater than and closest to Right if Right is not an integer; or Top′ is an integer greater than and closest to Top if Top is not an integer, Left′ is an integer greater than and closest to Left if Left is not an integer, Bottom′ is an integer smaller than and closest to Bottom if Bottom is not an integer, and Right′ is an integer smaller than and closest to Right if Right is not an integer, and
W′=Right ‘−Left’, and L′=Bottom′−Top′.

5. The system as claimed in claim 1, wherein:
the element picture set further includes a third picture, the third picture having an original specification;
said picture transformation module further generates a corrected specification from the original specification of the third picture in accordance with the specification transformation rule, and generates a transformed third picture based on the third picture, with reference to the original and corrected specifications associated with the third picture;
said packaging module further packages the transformed third picture into the mobile application together with the page metadata, the preview page, the background page, the transformed first picture and the transformed second picture; and
when the mobile device is in the view mode while the interactive element is being triggered, the background page is displayed on the mobile device together with the transformed third picture by superimposing the transformed third picture on the background page.

6. The system as claimed in claim 5, wherein the corrected specification for each of the transformed static picture, the transformed first picture, the transformed second picture and the transformed third picture includes two integer corrected dimension values, and a corrected main positioning point that has a two-dimensional coordinate of two integer coordinate components.

7. The system as claimed in claim 1, wherein:
the element picture set further includes a resultant picture;
said packaging module further packages the resultant picture into the mobile application; and
when the mobile device is in the view mode while the interactive element has already been triggered, the background page and the transformed second picture are displayed on the mobile device together with the resultant picture by superimposing the resultant picture on the transformed second picture and on the background page.

8. A method for generating a mobile application based on page metadata, the page metadata corresponding to a plurality of digital pictures that are associated with at least one static object and at least one interactive element, said method being to be implemented by a system including an editor module, a picture transformation module, a page generation module and a packaging module, said method comprising the steps of:
a) defining, by the editor module, at least one static picture, and at least one element picture set, which includes a first picture and a second picture, from among the digital pictures based on the page metadata, the static picture serving as the static object, the element picture set being associated with the interactive element, each of the static picture and the first and second pictures having an original specification;
b) by the picture transformation module, generating corrected specifications respectively from the original specifications respectively of the static picture and the first and second pictures in accordance with a specification transformation rule, and generating a transformed static picture based on the static picture with reference to the original and corrected specifications associated with the static picture, a transformed first picture based on the first picture with reference to the original and corrected specifications associated with the first picture, and a transformed second picture based on the second picture with reference to the original and corrected specifications associated with the second picture;
c) by the page generation module, generating a preview page based on the transformed static picture and the transformed first picture, and generating, based on the transformed static picture, a background page that corresponds to the preview page; and
d) packaging, by the packaging module, the page metadata, the preview page, the background page, the transformed first picture and the transformed second picture to generate the mobile application;
wherein, after the mobile application is loaded into and executed by a mobile device, the mobile application enables the mobile device to operate in one of a preview mode and a view mode,
the preview page is capable of being displayed on the mobile device when the mobile device is in the preview mode,
the background page is capable of being displayed on the mobile device together with the transformed first picture by superimposing the transformed first picture on the background page when the mobile device is in the view mode while the interactive element has not yet been triggered, and
the background page is displayed on the mobile device together with the transformed second picture by superimposing the transformed second picture on the background page when the mobile device is in the view mode while the interactive element has already been triggered.

9. The method as claimed in claim 8, wherein, in step b), the corrected specifications serve respectively as specifications of the transformed static picture, the transformed first picture and the transformed second picture, and each of the corrected specifications includes two integer corrected dimension values, and a corrected main positioning point that has a two-dimensional coordinate of two integer coordinate components.

10. The method as claimed in claim 9, wherein each of the static picture, the first and second pictures, the transformed static picture, the transformed first picture and the transformed second picture is a rectangular image block, the rectangular image block for each of the transformed static picture, the transformed first picture and the transformed second picture having an integer corrected width value and an integer corrected length value that serve as the integer corrected dimension values of the corresponding corrected specification.

11. The method as claimed in claim 9, wherein:
each of the static picture and the first and second pictures is a rectangular image block, and the original specification for each of the static picture and the first and second pictures includes an original width value (W), an original length value (L), a main positioning point located at an upper left corner of the rectangular image block, and an auxiliary positioning point located at a lower right corner of the rectangular image block;
the corrected specification for each of the transformed static picture, the transformed first picture and the transformed second picture includes a corrected width value (W′) and a corrected length value (L′), which serve as the corrected dimension values, the corrected main positioning point located at an upper left corner of the rectangular image block, and a corrected auxiliary positioning point located at a lower right corner of the rectangular image block; and
the two-dimensional coordinates of the main and auxiliary positioning points are represented respectively as (Left, Top) and (Right, Bottom), where Right=Left+W and Bottom=Top+L, and the two-dimensional coordinates of the corrected main and auxiliary positioning points are represented respectively as (Left′, Top′) and (Right′, Bottom′),
according to the specification transformation rule,
Top′ is an integer smaller than and closest to Top if Top is not an integer, and Left′ is an integer smaller than and closest to Left if Left is not an integer, Bottom′ is an integer greater than and closest to Bottom if Bottom is not an integer, and Right′ is an integer greater than and closest to Right if Right is not an integer; or Top′ is an integer greater than and closest to Top if Top is not an integer, and Left′ is an integer greater than and closest to Left if Left is not an integer, Bottom′ is an integer smaller than and closest to Bottom if Bottom is not an integer, and Right′ is an integer smaller than and closest to Right if Right is not an integer, and
W′=Right′−Left′, and L′=Bottom′−Top′.

12. The method as claimed in claim 8, wherein:
instep a), the element picture set further includes a third picture, the third picture having an original specification;
in step b), the picture transformation module further generates a corrected specification from the original specification of the third picture in accordance with the specification transformation rule, and generates a transformed third picture based on the third picture with reference to the original and corrected specifications associated with the third picture;
in step d), the packaging module further packages the transformed third picture into the mobile application together with the page metadata, the preview page, the background page, the transformed first picture and the transformed second picture; and
when the mobile device is in the view mode while the interactive element is being triggered, the background page is displayed on the mobile device together with the transformed third picture by superimposing the transformed third picture on the background page.

13. The method as claimed in claim 12, wherein the corrected specification for each of the transformed static picture, the transformed first picture, the transformed second picture and the transformed third picture includes two integer corrected dimension values, and a corrected main positioning point that has a two-dimensional coordinate of two integer coordinate components.

14. The method as claimed in claim 8, wherein:
instep a), the element picture set further includes a resultant picture;
in step d), the packaging module further packages the resultant picture into the mobile application; and
when the mobile device is in the view mode while the interactive element has already been triggered, the background page and the transformed second picture are displayed on the mobile device together with the resultant picture by superimposing the resultant picture on the transformed second picture and on the background page.

15. A computer program product, stored on a non-transitory computer readable medium, for generating a mobile application based on page metadata, the page metadata corresponding to a plurality of digital pictures that are associated with at least one static object and at least one interactive element, said computer program product comprising program instructions for causing a computer to:
define at least one static picture, and at least one element picture set, which includes a first picture and a second picture, from among the digital pictures based on the page metadata, the static picture constructing the static object, the element picture set being associated with the interactive element, each of the static picture and the first and second pictures having an original specification;
generate corrected specifications respectively from the original specifications respectively of the static picture and the first and second pictures in accordance with a specification transformation rule, and generate a transformed static picture based on the static picture with reference to the original and corrected specifications associated with the static picture, a transformed first picture based on the first picture with reference to the original and corrected specifications associated with the first picture, and a transformed second picture based on the second picture with reference to the original and corrected specifications associated with the second picture;
generate a preview page based on the transformed static picture and the transformed first picture, and generate, based on the transformed static picture, a background page that corresponds to the preview page; and
package the page metadata, the preview page, the background page, the transformed first picture and the transformed second picture to generate the mobile application;
wherein, after the application is loaded into and executed by a mobile device, the mobile application enables the mobile device to operate in one of a preview mode and a view mode,
the preview page is capable of being displayed on the mobile device when the mobile device is in the preview mode,
the background page is capable of being displayed on the mobile device together with the transformed first picture by superimposing the transformed first picture on the background page when the mobile device is in the view mode while the interactive element has not yet been triggered, and
the background page is displayed on the mobile device together with the transformed second picture by superimposing the transformed second picture on the background page when the mobile device is in the view mode while the interactive element has already been triggered.
